(19) United States
(12) Patent Application Publication
(10) Pub. No.: US 2024/0032172 A1
(43) Pub. Date: Jan. 25, 2024

(54) LED DIMMING CIRCUITRY

(71) Applicant: ABL IP Holding, LLC, Conyers, GA (US)

(72) Inventor: Victor Hugo RODRIGUEZ ORTIZ, Nuevo Leon (MX)

(21) Appl. No.: 17/814,014

(22) Filed: Jul. 21, 2022

(51) Int. Cl. H05B 45/3725; H02M 1/14; H02M 3/00; H02M 3/335; H05B 45/10; H05B 45/36

(52) U.S. Cl. CPC H05B 45/3725; H02M 1/14; H02M 3/01; H02M 3/33571; H05B 45/10; H05B 45/36

(57) ABSTRACT

A dimming and control circuitry for at least one light emitting diode (LED) load. The dimming and control circuitry includes notch filter circuitry coupled to the transformer circuitry; the notch filter circuitry having an approximately zero impedance value at a selected notch filter resonant frequency; wherein the selected notch filter resonant frequency is based on a maximum switching frequency of a plurality of switches and a resonant frequency of a resonant tank; and wherein the notch filter circuitry operates to decrease current delivered to the at least one LED load at switching frequencies between the resonant frequency of the resonant tank circuitry and the selected notch filter resonant frequency, and to reduce current delivered to the at least one LED load to approximately zero at the selected notch filter resonant frequency.

### FIELD

The present disclosure relates to LED dimming circuitry.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIGS. 1A and 1B illustrate block diagrams of LED dimming and control circuitry according to various embodiments of the present disclosure;

FIG. 2 illustrates a circuit diagram of an example LED dimming and control circuit according to one embodiment of the present disclosure; and

FIGS. 3A and 3B illustrate example signal plots of the example LED dimming and control circuit diagram of FIG. 2;

FIGS. 4A, 4B and 4C illustrate example equivalent circuit diagrams for determining circuit component values and values of the notch filter circuitry described herein; and

FIG. 5 illustrates a flowchart of LED dimming and control operations according to various embodiments of the present disclosure.

Although the following Detailed Description will proceed with reference being made to illustrative embodiments, many alternatives, modifications and variations thereof will be apparent to those skilled in the art.

### DETAILED DESCRIPTION

This disclosure provides light emitting diode (LED) dimming circuitry. In embodiments described herein, dimming control is enhanced by providing a notch filter to provide an additional resonant network. In one embodiment, an LC notch filter circuit is coupled to a secondary winding of a transformer associated with a driving circuit for one or more LEDs. The LC notch circuit operates to provide approximately zero impedance at a selected frequency, thus causing current delivered to the one or more LEDs to drop to approximately zero. In another embodiment, the LC notch filter circuit is coupled to a primary winding of the transformer, with similar results of causing current delivered to the one or more LEDs to drop to approximately zero at a selected frequency.

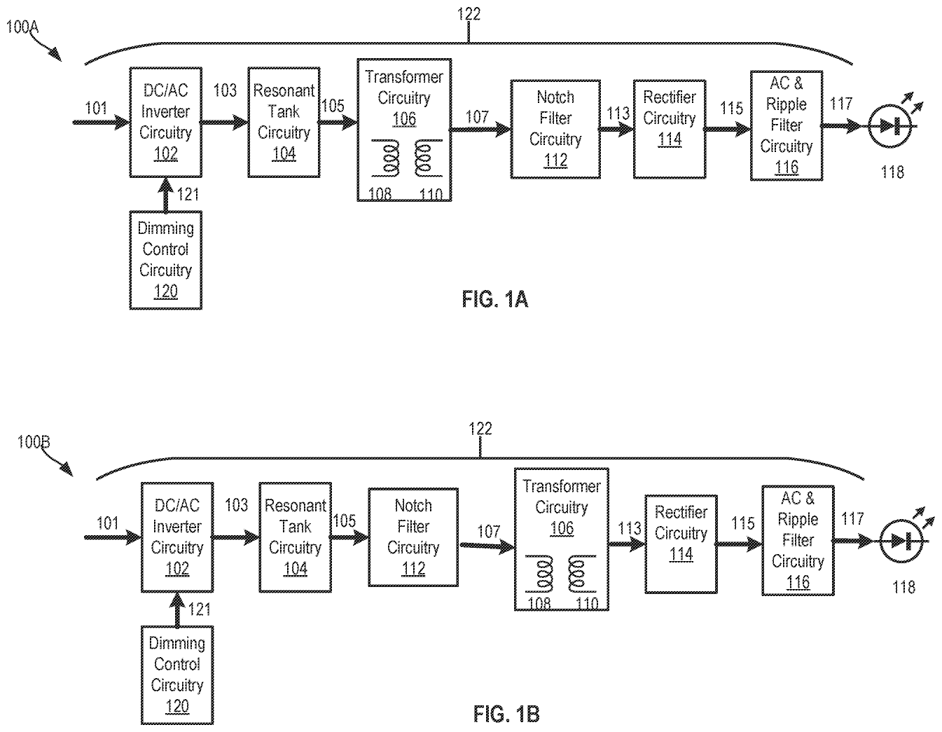

FIGS. 1A and 1B illustrate block diagrams of LED dimming and control circuitry 100A and 100B according to various embodiments of the present disclosure. Taking first FIG. 1A, the LED dimming and control circuitry 100A generally includes a controllable power supply 122 to deliver controllable DC power to one or more LED loads 118. The LED dimming and control circuitry 100A includes DC/AC inverter circuitry 102 generally configured to generate an AC signal 103 from a DC source 101. The DC source 101 may include, a DC voltage derived from a boost circuit to generate, for example 400-800 V DC., and/or other DC source. The DC/AC inverter circuitry 102 may include, for example, known switching inverter circuit topologies (e.g., half-bridge inverter (2 switch topology), full-bridge inverter (4 switch topology), etc.) and/or other known and/or proprietary inverter topologies. The switches associated with the DC/AC inverter circuitry 102 may include any known type of switches (e.g., bi-polar junction transistor (BJT), field-effect transistor (FET), etc.) and or other known and/or proprietary switches. As a general matter, the AC signal 103 generated by the DC/AC inverter circuitry 102 is a square wave signal having a frequency based on the switching frequency of the switches of the DC/AC inverter circuitry 102.

The LED dimming and control circuitry 100A also includes resonant tank circuitry 104 to receive the AC signal 103 and generate a sinusoidal (or quasi-sinusoidal) AC signal 105, having a frequency based on the frequency of the AC signal 103. The resonant tank circuitry 104 generally includes reactive components (e.g., capacitors/inductors) which collectively provide a resonant frequency of operation, where the resonant frequency causes the AC signal 105 to achieve maximum value, and the resonant frequency is based on the switching frequency of the DC/AC inverter circuitry 102. As will be described below, current (and thus power) delivered to a load may thus, at least in part, be controlled by controlling the switching frequency of the DC/AC inverter circuitry 102.

The LED dimming and control circuitry 100A also includes transformer circuitry 106 generally including a primary side 108 and a secondary side 110. The transformer circuitry 106 may operate as a step-up or step-down transformer, depending on a desired output voltage for the LED load 118. The primary side 108 of the transformer circuitry receives the AC signal 105 from the resonant tank circuitry 104, and depending on the operation of the transformer, cooperates with the secondary side 110 to generate a stepped-up or stepped-down AC signal 107. The LED dimming and control circuitry 100A also includes notch filter circuitry 112 coupled in parallel with the secondary side 110 of the transformer circuitry 106 to generate a controllably reduced AC signal 113. As will be described in greater detail below, the notch filter circuitry 112 is generally configured to provide an approximately zero impedance path to ground of the AC signal 107 at a selected frequency. The notch filter circuitry 112 advantageously enables very low dimming of the LED load(s) 118 (e.g., 1% dimming or less) while enabling the switching frequency of the inverter circuitry 102 to remain within relatively low range. For example, in conventional LED power supply topologies switching frequencies of 300 to 400 kHz are required to obtain low dimming levels (e.g., 1% or less). In contrast to conventional power supply topologies, the notch filter circuitry 112 enables low dimming control (e.g., 1% dimming or less) at much lower switching frequencies, for example, switching frequencies between 100 to 200 kHz.

The LED dimming and control circuitry 100A also includes rectifier circuitry 114 to generate a DC signal 115 from the AC signal 113 from the notch filter circuitry 112. The rectifier circuitry 114 may include, for example, full wave rectifier circuitry (e.g., 4 diode topology), half wave rectifier circuitry (e.g., 2 diode topology), etc., and/or other known and/or proprietary rectifier topologies. The LED dimming and control circuitry 100A may also include AC & ripple filter circuitry 116 generally configured to generate a “smooth” DC signal 117 by reducing or eliminating AC signal remnants in the DC signal 115. The filtered DC signal 117 provides DC power to one or more LED loads 118.

The LED dimming and control circuitry 100A also includes dimming control circuitry 120 generally configured to control a switching frequency of the DC/AC inverter circuitry 102. As a general matter, when the switches of the DC/AC inverter circuitry 102 are switching at or near the resonant frequency of the resonant tank circuitry 104, maximum power is delivered to the LED load(s) 118, and thus the LED load(s) 118 operate at peak or near-peak brightness at this resonant frequency. As the switching frequency is increased (or decreased) away from the resonant frequency of the resonant tank circuitry 104, less power is delivered to the LED load(s) 118, thus dimming the LED load(s) 118. The dimming control circuitry 120 may include, for example, electromechanical components (e.g., in the form of dimming switches, dimming sliders, dimming knobs, etc.) to control a switching frequency of the DC/AC inverter circuitry 102, programmable components (e.g., in the form of user-selectable and/or automated dimming control circuits, etc.), and/or other known and/or propriety dimming control circuitry generally configured to generate a control signal 121 to control the switching frequency of the switches of the DC/AC inverter circuitry 102. The control signal 121 may include, for example, a pulse-width modulation (PWM) signal having a selected duty cycle (e.g., 50%, 49%, etc.) to drive the switches of the DC/AC inverter circuitry 102, as is well understood in the art.

As noted above, conventional dimming control cannot achieve low dimming levels (e.g., 1% dimming or less) without a dramatic increase in switching frequency of the switches of the DC/AC inverter circuitry 102. Such a dramatic increase in switching frequency may be beyond the tolerance limits of the switches, and generally leads to increased complexity and cost of the circuit design. Accordingly, the teachings of the present disclosure provide the notch filter circuitry 112 that generally includes reactive components (e.g., inductor and capacitor) to enable low dimming levels to be achieved by shunting load current, by providing an approximately zero impedance value at a selected notch filter resonant frequency. As used herein “approximately zero impedance value” means a minimal impedance value given the inherent resistance values of the reactive components of the notch filter circuitry. The selected notch frequency is based on the value of the reactive components, and may be selected to be between the resonant frequency of the tank circuitry 104 and a selected maximum switching frequency of the switches of the inverter circuitry 102, where the selected maximum switching frequency is selected so that the switching frequency of the of the switches of the DC/AC inverter circuitry 102 remain within tolerance limits. In addition, the selected notch frequency may be selected to provide a wide range of dimming control so that small changes in switching frequency do not produce large changes in power delivered to the LED load(s) 118.

In embodiments herein, the notch filter circuitry 112 includes a notch capacitor and notch inductor in series and, together, in parallel with the secondary side 110 of the transformer 106. The impedance value and notch filter resonant frequency of the notch filter circuitry 112 are generally based on a capacitance value (C) of the notch capacitor, an inductance value (L) of the notch inductor, the resonant frequency of the tank circuitry 104, and the switching frequency of the switches of the DC/AC inverter circuitry 102. Determining values for the notch capacitor and notch inductor is described more fully below.

FIG. 1B illustrates a block diagrams of LED dimming and control circuitry 100B according to various embodiments of the present disclosure. The LED dimming and control circuitry 100B of FIG. 1B is similar to the LED dimming and control circuitry 100A of FIG. 1A, except that the notch filter circuitry 112 is coupled to the primary side 108 of the transformer 106 (instead of coupled to the secondary side 110). The operation and dimming control of the LED dimming and control circuitry 100B is similar to the LED dimming and control circuitry 100A described above.

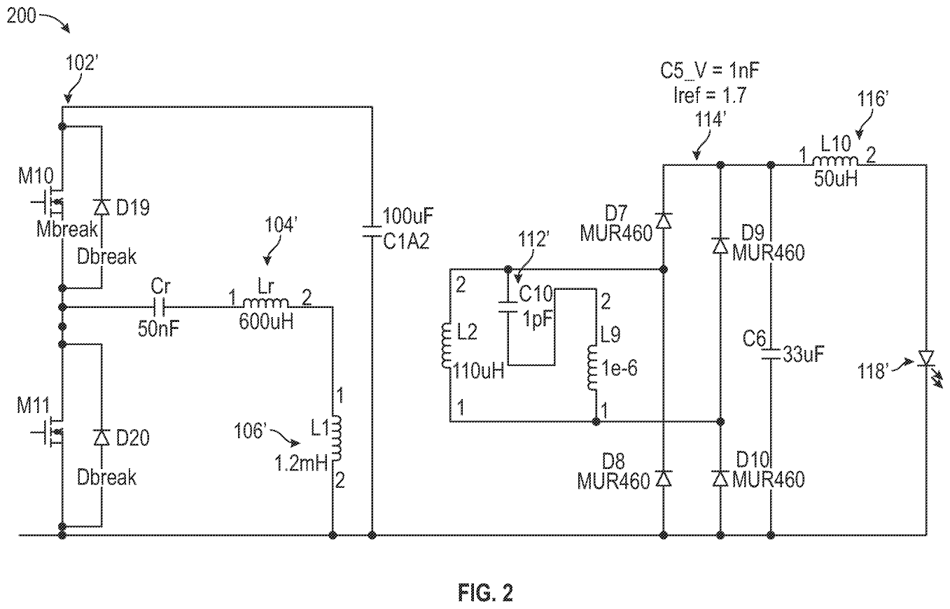

FIG. 2 illustrates a circuit diagram of an example LED dimming and control circuit 200 according to one embodiment of the present disclosure. The example LED dimming and control circuit 200 includes AC/DC inverter circuitry 102′. The inverter circuitry 102″ is a half bridge inverter that includes two switches, as illustrated. The example LED dimming and control circuit 200 also includes resonant tank circuitry 104′ (including capacitor Cr and inductor Lr) coupled between the switches of the inverter circuitry, transformer circuitry 106′ (including primary side L1 and secondary side L2) coupled as illustrated, rectifier circuitry 114′ (including diodes D7-D10), and AC and ripple filter circuitry 116′ (including inductor L10 and capacitor C6). The example LED dimming and control circuit 200 is generally configured to provide controllable dimming power to an LED load 118′.

The example LED dimming and control circuit 200 also includes notch filter circuitry 112′ coupled to the secondary side of the transformer 106′. In this example embodiment, the notch filter circuitry 112′ includes notch capacitor C10 and notch inductor L9 coupled in series, and which, together, are coupled in parallel to the secondary side (L2) of the transformer 106′. The notch filter circuitry 112′ provides a zero (or near-zero) impedance value, thus shunting power delivered to the LED 118′ to provide dimming control, as described in more detail below.

The particular circuit component values may be selected based on, for example, operational frequencies, load power requirements, etc., as is well understood in the art. By way of a specific example, the circuit component values to controllably drive a variety of conventional, off-the-shelf, and/or proprietary LED devices, for example LED bulbs and lighting provided by Osram, Nichia, Lumited, Seul, etc., are as follows:
Cr: 50 nF;
Lr: 600 uH;
L1: 1.2 mH
C1A2: 100 uF;
L2: 110 uH;
C10: 1 pF;
L9: 0.000001 H
C6: 33 uF
L10: 50 uH

Of course, these values are only provided as one specific example, and the present disclosure is in no way limited to these values or the circuit topology depicted in FIG. 2.

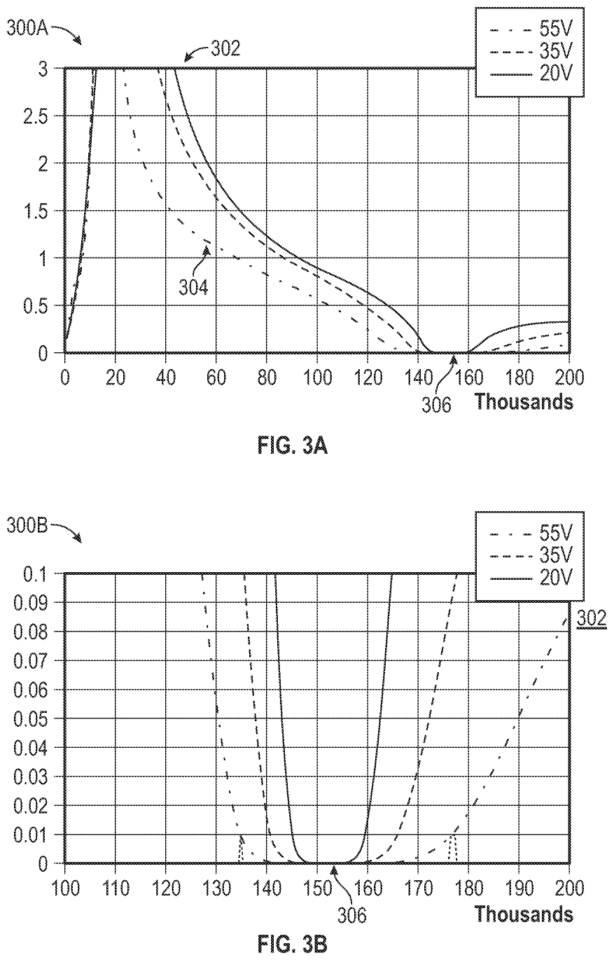

FIGS. 3A and 3B illustrate example signal plots 300A and 300B of the example LED dimming and control circuit 200 of FIG. 2. In particular, the signal plots 300A and 300B illustrate the operational effects of the notch filter circuitry 112′ on current delivered to the LED load 118′ (y-axis) as a function of operational switching frequency (x-axis). In addition, the signal plots 300A and 300B illustrates these operational effects for three example DC voltage levels: 20V, 35V and 55V. In these example signal plots, it may be assumed that a resonant frequency of the tank circuitry 104′ is approximately 20 kHz. As illustrated in FIG. 3A at point 302, the notch filter circuitry 112′ operates as a pass through circuit at the resonant frequency of the tank circuitry 104′ (i.e., at the resonant frequency of the tank circuitry 104′, the notch filter circuitry 112′ does not significantly limit power delivered to the LED load(s) 118′). As the switching frequency increases, the notch filter circuitry 112′ begins to limit current delivered to the LED load(s) 118′, as illustrated at 304. As the switching frequency (of the inverter) is increased, the notch filter circuitry 112′ decreases current to the load by shunting current. Decreasing load current continues for switching frequencies between approximately 20 kHz and approximately 150 kHz, as shown at 304. The selected notch filter resonant frequency is shown at 306, representing approximately zero impedance of the notch filter circuitry 112′ in which approximately all of the current is shunted, and thus the LED load 118′ receives less than 1% of maximum current. In other words, the LED load 118′ receives approximately zero current at this resonant frequency of the notch filter. As used herein, “Approximately zero” load current means a minimal load current given inherent resistances of the components of the circuit. This point 306 represents a dimming of 1% or less of the LED load 118′. FIG. 3B illustrates the selected notch filter resonant frequency (306) in greater detail. Of note, since the selected notch frequency (306) is approximately an order of magnitude greater than the resonant frequency (302), a wide range of dimming control is provided. In addition, assuming that a maximum switching frequency of the switches of the inverter 102′ is approximately 200 kHz, the selected notch frequency (306) is selected to be less than the switching frequency (in this example, the selected notch filter resonant frequency is 150 kHz and the maximum switching frequency is 200 kHz). In other embodiments, the selected notch frequency is selected to be less than 90% of the maximum switching frequency, thereby ensuring low dimming control within the operating tolerance of the switches. Absent the notch filter circuitry 112′, the circuit 200 could not achieve dimming of 1% or less unless the switching frequency was much greater than 200 kHz (which increases the expense and complexity of the circuit design).

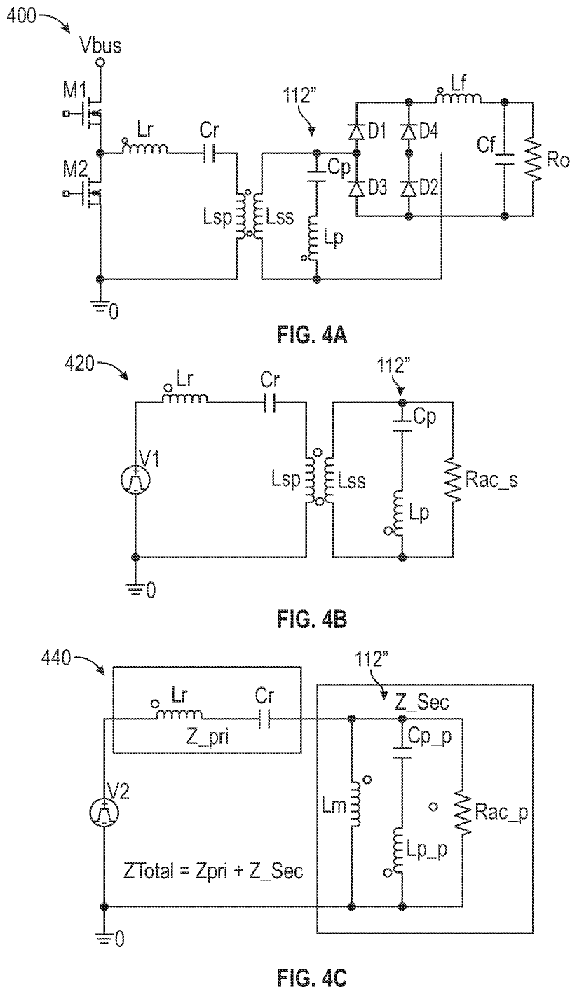

FIGS. 4A, 4B and 4C illustrate example equivalent circuit diagrams for determining circuit component values and values of the notch filter circuitry described herein. The circuit diagram 400 of FIG. 4A illustrates another example LED dimming and control circuitry according to one embodiment, in which the notch filter circuitry 112″ include notch capacitor Cp and notch inductor Lp coupled in series, and together coupled in parallel to the secondary side of the transformer (Lss). In the examples of FIGS. 4A-4C, circuit component values are determined using fundamental harmonic approximation (FHA) methodology. Component values may be selected by initially determining a ratio (N) of the primary side of the transformer circuitry (Lsp) to the secondary side of the transformer circuitry (Lss). Lsp is a safety primary winding, Lss is a safety secondary winding, and Lf is filtering inductance. In these examples, the bus voltage (Vbus) may be 460 VDC, 800 VDC, etc.

As illustrated in the equivalent circuit diagram 420 of FIG. 4B, the output stage including the AC and ripple filter circuitry (Lf and Cf), the load R0 and rectifier circuitry are illustrated as an equivalent reactance Rac. In addition, the switch circuitry is illustrated as an AC source (V1). As illustrated in the equivalent circuit diagram 440 of FIG. 4C, the secondary side of the transformer (Lss), notch inductor Lp, notch capacitor Cp and Rac are reflected to the primary side of the transformer (Lsp) as Lpp, Cpp, and Racp. Lpp, Cpp, and Racp are in parallel to the reflected primary side of the transformer Lm. The equivalent reactance is shown as Z_sec. The value of N may be initially determined as:

$$N = \frac{Npri}{Nsec} = \frac{V bus}{2 * V led} ;$$

where Npri is the windings of the primary side of the transformer, Nsec is the windings of the secondary side of the transformer. Vbus is DC voltage and Vled is the desired voltage on the LED load(s). Note that Npri/Nsec is equivalent to VBus/2Vled.

The resonant frequency of the tank circuitry (Lr and Cr) is determined to deliver maximum power transfer to the LED load(s), and the values of Lr and Cr may be determined as follows:

$$ω = 2 * π * F$$

$${X}_{Cr} = \frac{1}{ω * C r}$$

$${X}_{Lr} = ω * L r$$

There may a direct relation between Lm and the current circulating on the primary winding of the transformer. Thus, if a value of Lm is selected to be too small, a high primary current will result which may generate larger losses (and reduce efficiency of the circuit topology). On the other hand, if the value of Lm is selected to be too large, the primary current will decrease but this may present problems for higher frequency operation (since stored energy will not properly discharge due to a reduced time constant). Accordingly, Lm values of between 3 to 7 may be selected to avoid such issues. The reactance of Lm is therefore given as:

X_{Lm}=ω*Lₘ

As described above, the resonant frequency of the notch filter circuitry 112″ is a frequency value where the notch filter circuitry 112″ has approximately zero impedance value. Since Lp and Cp are coupled in series, the approximately zero impedance value is generally provided where the reactance of each are equal, i.e. XLp and XCp are equal. The resonant frequency (FO) of the notch filter circuitry 112″ may be expressed as a function of the values of Lp and Cp, and given as:

$$F o ( L p , C p ) = \frac{1}{2 * π * \sqrt{{L}_{p} * {C}_{p}}}$$

In some embodiments, the value for Cp may be selected based on widely-available commercial capacitors, and, as is understood in the art, customized inductance values are generally easier to obtain. However, it should be understood that any combination of Lp and Cp values may be used, and may be selected based on, for example, a cost and size of the inductor and capacitor. The value of Lp can be expressed as:

$${L}_{p} = \frac{{C}_{p}}{{( 2 * π * {F}_{o} )}^{2}}$$

Once the values of Lp and Cp are obtained, the circuit can be solved as follows:

$${X}_{L p} = ω * {L}_{p}$$

$${X}_{Cp} = \frac{1}{ω * Cp}$$

Lp and Cp are reflected to the primary side of the transformer using the value of N (relationship of the primary to the secondary), as follows:

$${X}_{Lpp} = ω * {L}_{p} * {N}^{2}$$

$${X}_{Cpp} = \frac{1}{ω * C p * {N}^{2}}$$

$${X}_{( {L}_{pp} \_ {C}_{pp} )} = {X}_{Lpp} + {X}_{Cpp}$$

The value of Ro is based on a desired LED voltage and current at full power, as follows:

$$R o = \frac{V led}{Iled}$$

AC resistance reflected to the primary of the transformer may be determined as:

$${R}_{acp} = \frac{8 * R o * {N}^{2}}{{π}^{2}}$$

Circuit component values may be solved in two parts: the first is the solution of Lp, Cp and Rac reflected to primary and in parallel to Lm that is the magnetizing inductance, as follows:

$${X}_{( Lpp \_ Cpp )} // {R}_{acp} = \frac{{X}_{( {L}_{pp} \_ {C}_{pp} )} * {R}_{acp}}{{X}_{( {L}_{pp} \_ {C}_{pp} )} + {R}_{acp}}$$

$$( {X}_{( Lpp \_ Cpp )} // {R}_{acp} ) // {X}_{L m} = \frac{( {X}_{( Lpp \_ Cpp )} // {R}_{acp} ) * {X}_{L m}}{( {X}_{( Lpp \_ Cpp )} // {R}_{acp} ) + {X}_{L m}} = {Z}_{S E C}$$

The second part is the primary stage, and the solution for the Lr and Cr in series may be determined as:

Z_{PRI}=X_{Lr}+X_{Cr}

The total impedance for the resonant tank circuitry may be determined as: Z_{Total}=Z_{PRI}+Z_{SEC}; Where primary current is

$${I}_{PRI} = {V}_{B U S} * \frac{\sqrt{2}}{π * \vert {Z}_{PRI} \vert} ;$$

and secondary current is based on the relation from primary to secondary I_{SEC}=|I_{PRI}*N|.

Thus, current delivered to the LED load (Iled) is expressed as:

$${I}_{L E D} = {I}_{S E C} * \frac{\vert {X}_{L p} - {X}_{C p} \vert}{\vert {X}_{L p} - {X}_{C p} \vert + {R}_{o}}$$

As may be appreciated, the foregoing operations to solve for component and circuit values may include iterative approaches. For example, a first set of calculations may be an approximation, since the total impedance is a function of Ro, and Ro is the equivalent resistance for the LED, but Ro is function of current delivered to the LED loads (which, again, depends on total impedance).

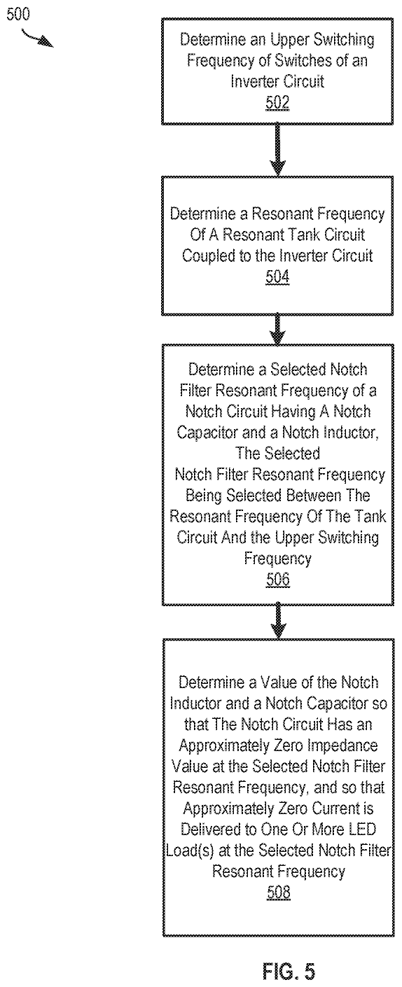

FIG. 5 illustrates a flowchart 500 of LED dimming and control operations according to various embodiments of the present disclosure. Operations of this embodiment include determining an upper switching frequency for switches of an inverter circuit 502. An “upper” switching frequency may include, for example, a maximum switching frequency of the switches, a user-definable maximum switching frequency of the switches (for example, a switching frequency that is substantially less than a “rated” or tolerable switching frequency of the switches), etc. Operations of this embodiment also include determining a resonant frequency of a resonant tank circuit coupled to the inverter circuit 504. Operations of this embodiment also include determining a selected notch filter resonant frequency of a notch filter circuit having a notch capacitor and notch inductor, the selected notch filter resonant frequency being selected between the resonant frequency of the resonant tank circuit and the upper switching frequency of the switches 506. Operations of this embodiment also include determining a value of the notch capacitor and notch inductor so that the notch circuit has an approximately zero impedance value at the resonant frequency of the notch filter circuit, and so that approximately zero current is delivered to one or more LED load(s) at the selected resonant frequency of the notch filter circuit 508.

While FIG. 5 illustrates various operations according to one or more embodiments, it is to be understood that not all of the operations depicted in FIG. 54 are necessary for other embodiments. Indeed, it is fully contemplated herein that in other embodiments of the present disclosure, the operations depicted in FIG. 5, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

“Circuitry” or “circuit”, as used in any embodiment herein, may comprise, for example, singly or in any combination, hardwired circuitry, programmable circuitry such as processors comprising one or more individual instruction processing cores, state machine circuitry, and/or firmware that stores instructions executed by programmable circuitry and/or future computing circuitry including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), application-specific integrated circuit (ASIC), programmable logic devices (PLD), digital signal processors (DST), field programmable gate array (FPGA), logic gates, registers, semiconductor device, chips, microchips, chip sets, etc.

Any of the operations described herein, for example, operations associated with the dimming control circuitry 120, may be implemented in a system that includes one or more non-transitory storage devices having stored therein, individually or in combination, instructions that when executed by circuitry to perform the operations. The non-transitory storage device includes any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software executed by a programmable control device. Also, it is intended that operations described herein may be distributed across a plurality of physical devices, such as processing structures at more than one different physical location.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents, Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

1. Dimming and control circuitry for at least one light emitting diode (LED) load, comprising:
inverter circuitry including a plurality of switches to generate a first AC signal from a DC source, the first AC signal having a frequency based on a switching frequency of the plurality of switches;
resonant tank circuitry comprising a resonant inductor and a resonant capacitor coupled in series to receive the first AC signal and generate a second AC signal, the resonant tank circuitry having a resonant value based on the frequency of the first AC signal to generate a maximum value of the second AC signal;
transformer circuitry comprising a primary side and a secondary side, the primary side coupled in parallel with the resonant inductor and the resonant capacitor coupled in series to receive the second AC signal and generate a transformed AC signal; and
notch filter circuitry comprising a notch inductor and notch capacitor coupled in series and coupled in parallel to the secondary side of the transformer circuitry; the notch filter circuitry having an approximately zero impedance value at a selected notch filter resonant frequency; wherein the selected notch filter resonant frequency is based on a maximum switching frequency of the plurality of switches and the resonant frequency of the resonant tank circuitry; and wherein the notch filter circuitry operates to decrease current delivered to the at least one LED load at switching frequencies between the resonant frequency of the resonant tank circuitry and the selected notch frequency, and to reduce current delivered to the at least one LED load to approximately zero at the selected notch filter resonant frequency.

2. The dimming and control circuitry of claim 1, wherein the notch filter circuitry comprises a notch capacitor and notch inductor coupled in series, and together, coupled in parallel to a secondary side of the transformer circuitry.

3. (canceled)

4. (canceled)

5. The dimming and control circuitry of claim 1, wherein the selected notch filter resonant frequency is selected to be less than 90% of a maximum switching frequency of the plurality of switches.

6. The dimming and control circuitry of claim 1, further comprising rectifier circuitry coupled to the notch filter circuitry, the rectifier circuitry to generate a DC signal from the transformed AC signal.

7. The dimming and control circuitry of claim 6, further comprising AC and ripple filter circuitry coupled to the rectifier circuitry, the AC and ripple filter circuitry to reduce AC and ripple components of the DC signal.

8. The dimming and control circuitry of claim 1, further comprising dimming control circuitry to control the switching frequency of the switches of the inverter to control power delivered to the at least one LED load.

9. Dimming and control circuitry for at least one light emitting diode (LED) load, comprising:
half-bridge inverter circuitry including a first switch and a second switch to generate a first AC signal from a DC source, the first AC signal having a frequency based on a switching frequency of the first switch and the second switch;
resonant tank circuitry comprising a resonant inductor and a resonant capacitor coupled directly in series to receive the first AC signal and generate a second AC signal, the resonant tank circuitry having a resonant value based on the frequency of the first AC signal to generate a maximum value of the second AC signal;
transformer circuitry comprising a primary side and a secondary side, the primary side coupled directly in parallel with the resonant inductor and the resonant capacitor coupled directly in series, the transformer circuitry to receive the second AC signal and generate a transformed AC signal; and
notch filter circuitry including a notch capacitor and notch inductor coupled directly in series, and together, coupled directly in parallel to the secondary side of the transformer circuitry; the notch filter circuitry having an approximately zero impedance value at a selected notch frequency; wherein the selected notch frequency is based on a maximum switching frequency of the plurality of switches and the resonant frequency of the resonant tank circuitry; and wherein the notch filter circuitry operates to decrease current delivered to the at least one LED load at switching frequencies between the resonant frequency of the resonant tank circuitry and the selected notch frequency and to reduce current delivered to the at least one LED load to approximately zero at the selected notch frequency.

10. The dimming and control circuitry of claim 9, wherein the selected notch frequency is selected to be less than 90% of a maximum switching frequency of the plurality of switches.

11. The dimming and control circuitry of claim 9, further comprising rectifier circuitry coupled to the notch filter circuitry, the rectifier circuitry to generate a DC signal from the transformed AC signal.

12. The dimming and control circuitry of claim 11, further comprising AC and ripple filter circuitry coupled to the rectifier circuitry, the AC and ripple filter circuitry to reduce AC and ripple components of the DC signal.

13. The dimming and control circuitry of claim 9, further comprising dimming control circuitry to control the switching frequency of the switches of the inverter to control power delivered to the at least one LED load.

14-18. (canceled)
